(19) United States
(12) Patent Application Publication
(10) Pub. No.: US 2014/0241349 A1
(43) Pub. Date: Aug. 28, 2014

(54) OPENFLOW SWITCH AND PACKET PROCESSING METHOD THEREOF

(71) Applicant: ELECTRONICS AND TELECOMMUNICATIONS RESEARCH INSTITUTE, Daejeon (KR)

(72) Inventors: Bin Yeong YOON, Daejeon (KR); Sang Ki Kim, Daejeon (KR)

(73) Assignee: ELECTRONICS AND TELECOMMUNICATIONS RESEARCH INSTITUTE, Daejeon (KR)

(21) Appl. No.: 14/180,771

(22) Filed: Feb. 14, 2014

(30) Foreign Application Priority Data
Feb. 26, 2013 (KR) 10-2013-0020528

(51) Int. Cl. H04L 12/801

(52) U.S. Cl. CPC H04L 47/10
USPC 370/389

(57) ABSTRACT

An OpenFlow switch which processes a packet received from the outside is provided. The OpenFlow switch includes: a first table used to process a received packet; a second table used to create the first table; and a packet processor that manages the first table and the second table and controls the processing of the packet.

### CROSS-REFERENCE TO RELATED APPLICATION

This application claims priority to and the benefit of Korean Patent Application No. 10-2013-0020528 filed in the Korean Intellectual Property Office on Feb. 26, 2013, the entire contents of which are incorporated herein by reference.

### BACKGROUND OF THE INVENTION

(a) Field of the Invention

The present invention relates to an OpenFlow switch and a packet processing method thereof.

(b) Description of the Related Art

OpenFlow-based software-defined networking (hereinafter referred to as “SDN”) is a new networking technology which has become a hot issue, hotter than even cloud and big data, in the IT network field. SDN is a technology that converts conventional hardware-based, inflexible, and closed network architectures into open programmable network architectures. An essential feature of SDN is separation of the control plane for control and management functions from the existing network equipment by means of software.

The data plane and the control plane, separated from each other, employ the method of communicating via the OpenFlow protocol, which is a standard technology. This offers the advantage of letting users build and customize their own networks, without hiring network builders.

An OpenFlow-based SDN system includes a plurality of OpenFlow switches and an OpenFlow controller for controlling these switches. The OpenFlow controller provides flow control information (i.e., output port, QoS, etc.) for processing a received packet, and the OpenFlow switches process a packet based on the flow control information provided from the OpenFlow controller.

In general, an OpenFlow switch has an OpenFlow table for storing flow control information therein. Upon receiving a packet corresponding to a flow registered in the OpenFlow table, the OpenFlow switch processes the packet based on the flow control information.

On the other hand, upon receiving a packet corresponding to a flow not registered in the OpenFlow table, the OpenFlow switch forwards the packet to the OpenFlow controller because there is no flow control information. The OpenFlow controller analyzes the packet, generates flow control information, and forwards the flow control information, along with the packet, to the OpenFlow switch. The OpenFlow switch stores the forwarded flow control information in the OpenFlow table, and processes the packet.

Such an OpenFlow switch requires packet processing technology to efficiently manage bandwidth resources and increase efficiency of resource use.

### SUMMARY OF THE INVENTION

The present invention has been made in an effort to provide an OpenFlow switch, which increase the efficiency of resource use, and a packet processing method thereof.

An exemplary embodiment of the present invention provides an OpenFlow switch. The OpenFlow switch may include: a first table that stores a first information used to process a packet received from outside; a second table that stores a second information used to generate the first information; and a packet processor that manages the first table and the second table and controls the processing of the packet.

If a first flow corresponding to a first packet received from the outside is not registered in the first table but is in the second table, the packet processor may add the first flow to the first table by using the second table.

The packet processor may process the first packet by using the first table to which the first flow is added.

If the first flow corresponding to the first packet received from the outside is registered in neither of the first table and the second table, the packet processor may forward the first packet to an OpenFlow controller connected to the OpenFlow switch through an OpenFlow interface.

The packet processor may receive flow information corresponding to the first packet from the OpenFlow controller, and register the first flow in the second table based on the flow information.

The packet processor may add the first flow to the first table by using the second table in which the first flow is registered, and process the first packet by using the first table to which the first flow is added.

The first table may include a Timer field used to delete each flow, and the second table may include a Status field indicating the status of each flow.

If the first packet is not received during a period set in the Timer field, the packet processor may change the Status field of the flow corresponding to the first packet in the second table from active to inactive.

The packet processor may delete the flow corresponding to the first packet from the first table.

The packet processor may report information on the deleted flow to the OpenFlow controller connected to the OpenFlow switch through the OpenFlow interface.

The first table may further include a Rule field indicating packet identification information, an Action field indicating a packet processing method, and a Statistics field indicating a packet processing result.

The second table may further include a Rule field, an Action field, a Statistics field, and a Policy field indicating a policy on each flow.

Another exemplary embodiment of the present invention provides a packet processing method of an OpenFlow switch. The packet processing method may include: determining whether a first flow corresponding to a first packet received from outside is registered in a first table; if the first flow is not registered in the first table, determining whether the first flow is registered in the second table; if the first flow is not registered in the first table but is in the second table, adding the first flow to the first table by using the second table; and processing the first packet by using the first table to which the first flow is added.

The packet processing method may further include, if the first flow is registered in neither of the first table and the second table, forwarding the first packet to an OpenFlow controller connected to the OpenFlow switch through an OpenFlow interface.

The packet processing method may further include: receiving flow information corresponding to the first packet from the OpenFlow controller; and registering the first flow in the second table based on the flow information.

The packet processing method may further include: monitoring whether a second packet registered in the first table is received during a predetermined period; and if the second packet is not received during the predetermined period, deleting the flow corresponding to the second packet from the first table.

The packet processing method may further include reporting information on the deleted flow to the OpenFlow controller connected to the OpenFlow switch through the OpenFlow interface.

Yet another exemplary embodiment of the present invention provides a software-defined networking system. The system may include: an OpenFlow switch that processes a packet received from outside; and an OpenFlow controller connected to the OpenFlow switch through an OpenFlow interface, wherein the OpenFlow switch may include an OpenFlow table used to process the packet and a Forwarding table used to create the OpenFlow table.

If a first flow corresponding to a first packet is not registered in the OpenFlow table but is in the Forwarding table, the OpenFlow switch may add the first flow to the OpenFlow table by using the Forwarding table.

If the first packet registered in the OpenFlow table is not received during a predetermined period, the OpenFlow switch may delete the flow corresponding to the first packet from the OpenFlow table.

According to an exemplary embodiment of the present invention, the OpenFlow switch monitors the status of flows and withdraws the flows, thus increasing efficiency of network resource use.

### BRIEF DESCRIPTION OF THE DRAWINGS

FIG. 1 is a view showing the overall configuration of an OpenFlow-based SDN system in accordance with an exemplary embodiment of the present invention.

FIG. 2 is a view showing an OpenFlow table in accordance with the exemplary embodiment of the present invention.

FIG. 3 is a view showing a forwarding table in accordance with the exemplary embodiment of the present invention.

FIG. 4 is a view showing a method for an OpenFlow switch to process a packet in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

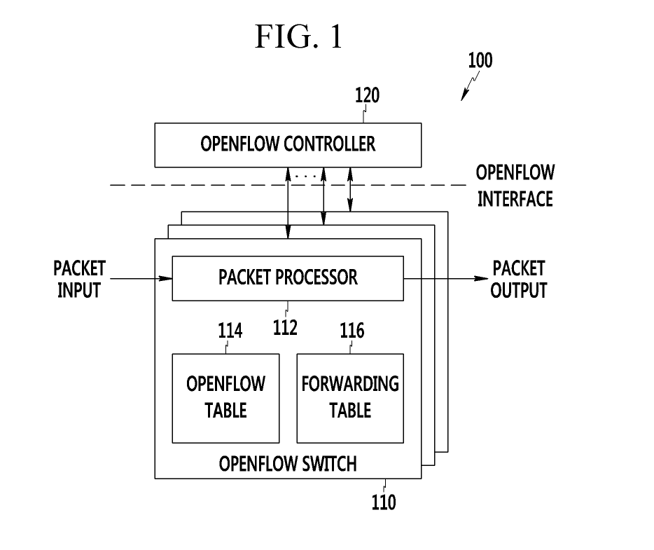

FIG. 1 is a view showing the overall configuration of an OpenFlow-based SDN system in accordance with an exemplary embodiment of the present invention.

As shown in FIG. 1, an SDN system 100 in accordance with an exemplary embodiment of the present invention includes an OpenFlow switch 110 and an OpenFlow controller 120. The OpenFlow switch 110 and the OpenFlow controller 120 are connected to each other via an OpenFlow interface recommended by the ONF (Open Networking Foundation). Although at least one OpenFlow switch 110 may be provided, the following description will be made on the assumption that one OpenFlow switch is provided, for convenience of explanation.

The OpenFlow controller 120 generates packet routing and control information for each flow (hereinafter referred to as “flow control information”) required to process a received packet, and forwards it to the OpenFlow switch 110.

The OpenFlow switch 110 processes a packet received (input) from the outside, based on the flow control information provided from the OpenFlow controller 120.

As shown in FIG. 1, the OpenFlow switch 110 in accordance with the exemplary embodiment of the present invention includes a packet processor 112, an OpenFlow table 114, and a forwarding table 116.

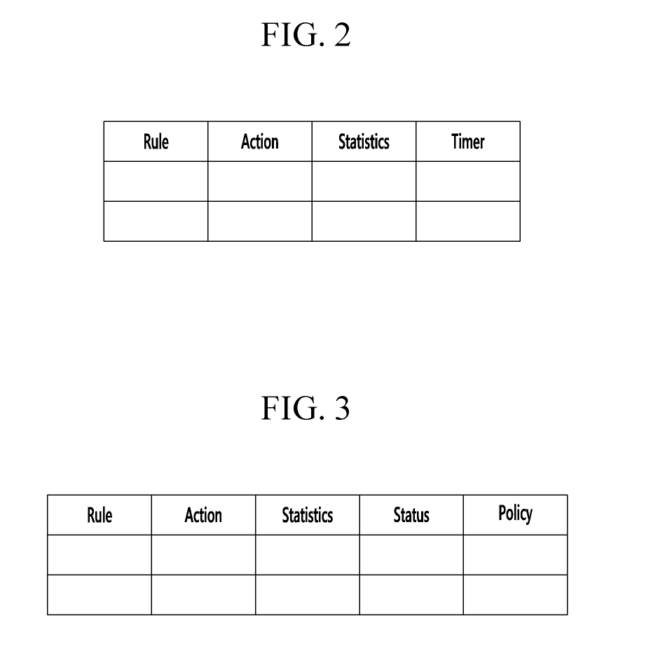

FIG. 2 is a view showing an OpenFlow table 114 in accordance with the exemplary embodiment of the present invention. The OpenFlow table 114 shown in FIG. 2 may consist of a number of tables as recommended by the ONF.

As shown in FIG. 2, the OpenFlow table 114 in accordance with the exemplary embodiment of the present invention includes a Rule field, an Action field, a Statistics field, and a Timer field, which are provided for each flow.

The Rule field contains packet identification information, the Action field contains a packet processing method (e.g., output port, etc.), and the Statistics field contains statistics information, which is a packet processing result. The Timer field is used to delete the flow if a packet corresponding to the flow is not received during a predetermined period of time.

A flow is identified by packet header information (i.e., IP or MAC header information), and packets of the same flow are processed in the same way.

FIG. 3 is a view showing a Forwarding table 116 in accordance with the exemplary embodiment of the present invention.

The Forwarding table 116 stores packet processing information for each flow that is forwarded from the OpenFlow controller 120 to the OpenFlow switch 110.

As shown in FIG. 3, the Forwarding table 116 in accordance with the exemplary embodiment of the present invention includes a Rule field, an Action field, a Statistics field, a Status field, and a Policy field. That is, the Forwarding table 116 includes a Policy field indicating policy information about each flow, in addition to the information required for the OpenFlow table 114. The Policy field contains information about allocated bandwidth and service grade, and is used to generate information about the packet processing method used for the OpenFlow switch 110 (i.e., information on the Action field).

The forwarding table 116 in accordance with the exemplary embodiment of the present invention further includes a Status field. The Status field displays active or inactive status.

Meanwhile, the packet processor 112 identifies a flow in which packets received from the outside belong, and processes the packets in three different ways depending on whether the flow is registered in the OpenFlow table 114 or in the Forwarding table 116. That is, the packet processor 112 processes the packet in different ways depending on whether i) the flow is registered in the OpenFlow table 114, or ii) the flow is not registered in the OpenFlow table 114 but is in the Forwarding table 116, or iii) the flow is registered in neither of the OpenFlow table 114 and the Forwarding table 116.

Hereinafter, a method for the packet processor 112 (i.e., OpenFlow switch) to process a packet in accordance with an exemplary embodiment of the present invention will be described in detail.

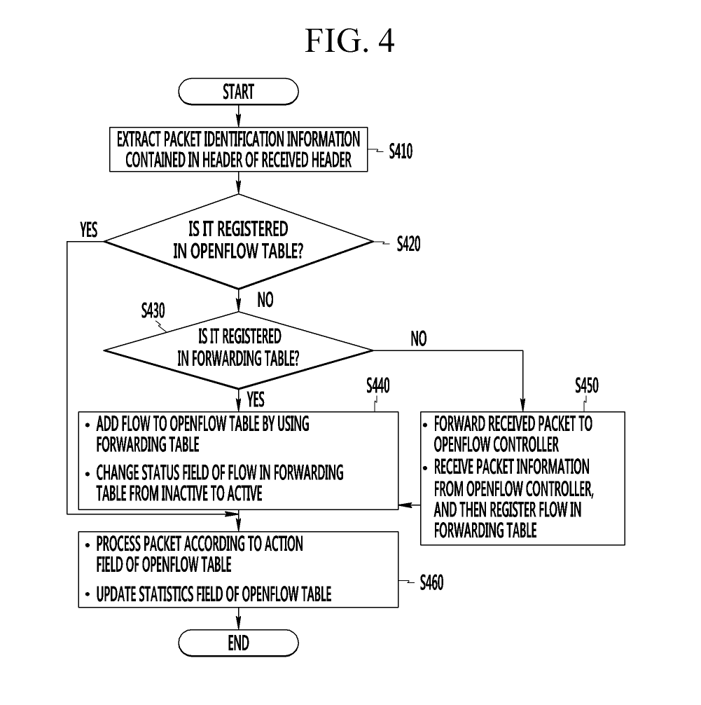

FIG. 4 is a view showing a method for an OpenFlow switch 110 to process a packet in accordance with an exemplary embodiment of the present invention.

First, the packet processor 112 extracts packet identification information (i.e., information corresponding to the Rule field) contained in the header of a received packet (S410). The packet identification information consists of a combination of an IP address, a MAC address, etc., and packets with the same packet identification information may be defined to belong to the same flow.

Next, the packet processor 112 checks whether the same flow (i.e., flow identification information) is registered in the OpenFlow table 114, based on the packet identification information (i.e., flow identification information) extracted from the header of the received packet (S420). That is, the packet processor 112 compares the packet identification information of the header of the received packet with the packet identification information registered in the Rule field of the OpenFlow table 114.

If the packet identification information of the header of the received packet is registered in the OpenFlow table 114 in step S420, the following step S460 is performed. That is, the packet processor 112 processes the received packet according to the Action field of the OpenFlow table 114, and updates the Statistics field of the OpenFlow table 114 with the packet processing result (S460).

If the packet identification information of the header of the received packet is not registered in the OpenFlow table 114 in step S420, the step S430 is performed. In step S430, the packet processor 112 checks whether the packet identification information of the header of the received packet is registered in the Forwarding table 116. That is, the packet processor 112 compares the packet identification information of the header of the received packet with the packet identification information registered in the Rule field of the Forwarding table 116.

If the packet identification information of the header of the received packet is registered in the Forwarding table 116 in step S430, step S440 is performed. In step S440, the packet processor 112 adds a flow to the OpenFlow table 114 by using the Forwarding table 116. That is, the packet processor 112 generates flow field information (i.e., Rule, Action, Statistics, etc.) of the OpenFlow table 114, based on the flow field information (i.e., Rule, Action, Statistics, etc.) registered in the Forwarding table 116. Then, the packet processor 112 changes the Status field, which is the flow status information in the Forwarding table 116, from inactive to active.

The packet processor 112 performs step S430, and then performs step S460 to implement packet processing. That is, the packet processor 112 processes the received packet according to the added Action field of the OpenFlow table, and updates the Statistics field of the OpenFlow table 114 with the packet processing result.

Next, if the packet identification information of the header of the received packet is not registered even in the Forwarding table 116, step S450 is performed.

In step S450, the packet processor 112 forwards the received packet to the OpenFlow controller 120. The OpenFlow controller 120 analyzes the forwarded received packet to generate information required to create a Forwarding table, and forwards the generated information, along with the packet, to the OpenFlow switch 110 (i.e., OpenFlow processor 112). That is, the OpenFlow controller 120 generates information, such as a Rule field, an Action field, and a Policy field, and forwards this information along with the packet to the OpenFlow processor 112.

Then, the packet processor 112 registers the flow information (Rule, Action, Policy, etc.) received from the OpenFlow controller 120 in the Forwarding table 116, and performs step S440. That is, the packet processor 112 adds a flow to the OpenFlow table 114 based on the new flow information registered in the Forwarding table 116. Then, the packet processor 112 changes the Status field, which is the flow status information in the Forwarding table 116, from inactive to active.

Meanwhile, the OpenFlow switch 110 in accordance with the exemplary embodiment of the present invention performs the following procedure to efficiently manage traffic resources, which will be described below in detail.

The OpenFlow switch 110 is operative to set a timer for each flow each time it generates a flow for efficient management of traffic resources, and to periodically monitor the flow status. As explained above, the OpenFlow table 114 includes a Timer field and the Forwarding table 116 includes a Status field.

If the packet processor 112 receives at least one packet during a predetermined period T, it keeps the Status field of the corresponding flow as active. That is, the Status field of the corresponding flow contained in the Forwarding table 116 is kept as active.

On the other hand, if the packet processor 112 does not receive at least one packet during a predetermined period T, it changes the Status field of the corresponding flow from active to inactive. That is, the Status field of the corresponding flow contained in the Forwarding table 116 is changed from active to inactive. Then, the packet processor 112 updates the Statistics field information of the Forwarding table 116, based on the Statistics field information of the OpenFlow table 114, and deletes the corresponding flow registered in the OpenFlow table.

The packet processor 112 reports the deletion of the corresponding flow to the OpenFlow controller 120, and the OpenFlow controller 120 may quickly reuse the bandwidth of the corresponding flow. That is, according to the exemplary embodiment of the present invention, if a flow is not received during a predetermined period, the corresponding flow is deleted, thus increasing the efficiency of resource use.

Meanwhile, when no packet is received from the OpenFlow switch 110, if a flow information change occurs, the OpenFlow controller 120 may forward updated flow information to the OpenFlow switch 110. Hereupon, the OpenFlow switch 110 may update the Forwarding table 116 and the OpenFlow table 114 with the received flow information.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An OpenFlow switch comprising:
a first table that stores a first information used to process a packet received from outside;
a second table that stores a second information used to generate the first information; and
a packet processor that manages the first table and the second table and controls the processing of the packet.

2. The OpenFlow switch of claim 1, wherein if a first flow corresponding to a first packet received from the outside is not registered in the first table but is in the second table, the packet processor adds the first flow to the first table by using the second table.

3. The OpenFlow switch of claim 2, wherein the packet processor processes the first packet by using the first table to which the first flow is added.

4. The OpenFlow switch of claim 1, wherein, if the first flow corresponding to the first packet received from the outside is registered in neither of the first table and the second table, the packet processor forwards the first packet to an OpenFlow controller connected to the OpenFlow switch through an OpenFlow interface.

5. The OpenFlow switch of claim 4, wherein the packet processor receives flow information corresponding to the first packet from the OpenFlow controller, and registers the first flow in the second table based on the flow information.

6. The OpenFlow switch of claim 5, wherein the packet processor adds the first flow to the first table by using the second table in which the first flow is registered, and processes the first packet by using the first table to which the first flow is added.

7. The OpenFlow switch of claim 1, wherein
the first table comprises a Timer field used to delete each flow, and
the second table comprises a Status field indicating the status of each flow.

8. The OpenFlow switch of claim 7, wherein, if the first packet is not received during a period set in the Timer field, the packet processor changes the Status field of the flow corresponding to the first packet in the second table from active to inactive.

9. The OpenFlow switch of claim 8, wherein the packet processor deletes the flow corresponding to the first packet from the first table.

10. The OpenFlow switch of claim 9, wherein the packet processor reports information on the deleted flow to the OpenFlow controller connected to the OpenFlow switch through the OpenFlow interface.

11. The OpenFlow switch of claim 7, wherein the first table further comprises a Rule field indicating packet identification information, an Action field indicating a packet processing method, and a Statistics field indicating a packet processing result.

12. The OpenFlow switch of claim 8, wherein the second table further comprises a Rule field, an Action field, a Statistics field, and a Policy field indicating a policy on each flow.

13. A packet processing method comprising:
determining whether a first flow corresponding to a first packet received from outside is registered in a first table;
if the first flow is not registered in the first table, determining whether the first flow is registered in the second table;
if the first flow is not registered in the first table but is in the second table, adding the first flow to the first table by using the second table; and
processing the first packet by using the first table to which the first flow is added.

14. The packet processing method of claim 13, further comprising, if the first flow is registered in neither of the first table and the second table, forwarding the first packet to an OpenFlow controller connected to the OpenFlow switch through an OpenFlow interface.

15. The packet processing method of claim 14, further comprising:
receiving flow information corresponding to the first packet from the OpenFlow controller; and
registering the first flow in the second table based on the flow information.

16. The packet processing method of claim 13, further comprising:
monitoring whether a second packet registered in the first table is received during a predetermined period; and
if the second packet is not received during the predetermined period, deleting the flow corresponding to the second packet from the first table.

17. The packet processing method of claim 16, further comprising reporting information on the deleted flow to the OpenFlow controller connected to the OpenFlow switch through the OpenFlow interface.

18. A software-defined networking system comprising:
an OpenFlow switch that processes a packet received from the outside; and
an OpenFlow controller connected to the OpenFlow switch through an OpenFlow interface,
wherein the OpenFlow switch comprises:
an OpenFlow table used to process the packet; and
a Forwarding table used to create the OpenFlow table.

19. The software-defined networking system of claim 18, wherein, if a first flow corresponding to a first packet is not registered in the OpenFlow table but is in the Forwarding table, the OpenFlow switch adds the first flow to the OpenFlow table by using the Forwarding table.

20. The software-defined networking system of claim 18, wherein, if the first packet registered in the OpenFlow table is not received during a predetermined period, the OpenFlow switch deletes the flow corresponding to the first packet from the OpenFlow table.
